(19) United States
(12) Patent Application Publication
(10) Pub. No.: US 2008/0001032 A1
(43) Pub. Date: Jan. 3, 2008

(54) Counter hijacking system for an airliner

(76) Inventor: Karl S. Zickefoose, Albany, GA (US)

Correspondence Address: THE INVENTORS NETWORK, INC., 332 ACADEMY STREET, CARNEGIE, PA, 15106, US

(21) Appl. No.: 11/480,019

(22) Filed: Jul. 3, 2006

(51) Int. Cl. B64D 11/00

(52) U.S. Cl. 244/118.5

(57) ABSTRACT

A counter hijacking system for an airliner that includes a fuselage divided into a passenger compartment and a cockpit separated by a bulkhead includes a series of concealed receivers in the passenger compartment that are interconnected to a cockpit alarm and activated by portable transmitters carried by the flight attendants to signal a dangerous situation occurring in the passenger compartment whereupon the pilot or co-pilot can engage a toggle switch that opens a flow valve so that a knockout agent can be introduced into the passenger compartment via the fuselage oxygen lines for rendering the flight attendants, the passengers, and the hijackers or terrorists unconscious while personnel in the cockpit remain conscious and unaffected as their oxygen is provided from a separate source. After a predetermined time the crewmembers enter the passenger compartment, revive the flight attendants by administration of a counter agent, and secure the hijackers or terrorists with restraints and/or stun guns after their identification by the revived flight attendants.

### FIELD OF THE INVENTION

The present invention pertains to counter hijacking systems for aircraft, and more particularly pertains to a crew-initiated counter hijacking system for an airliner that includes the automatic delivery of a knockout agent to subdue unruly passengers, hijackers and terrorists.

### BACKGROUND OF THE INVENTION

Unruly passengers, air piracy, hijackers and terrorists are threats that all airliners must be prepared to deal with on a daily basis. Such threats put the lives of the passengers and crewmembers in danger as physical harm could be inflicted on the passengers and crewmembers, and, in a worst-case scenario, the airliner could be brought down by the actions of the unruly passengers, hijackers and terrorists.

Given the importance in maintaining the seamless and uninterrupted functioning of airline companies and airline travel, for both national and international economics, and given the increasing dependence on air travel in the now global economy, various measures, systems, methods and devices have been conceived to thwart and prevent any type of incident - ranging from a drunken and boisterous passenger to the extreme threat from armed hijackers and terrorists. Thus, the prior art discloses a variety of measures and devices to deal with and safely contain the range of incidents that threaten crew and passengers with injury or possible death.

For example, the Birch patent (UK patent application GB 2,183,582 A) discloses a method to reduce the risk of injury or death due to air piracy by the introduction of various substances into the aircraft interior by ducting means provided in the structure of the aircraft.

The Anderson patent (U.S. Pat. No. 3,658,277) discloses an aircraft anti-hijacking structure that includes a rotatable structure between the pilot area and the passenger area wherein the rotatable structure rotates between an open position and a closed position where it aligns with stationary members to block access to the pilot area or entrap the hijacker within the rotatable structure.

The Gutman patent (U.S. Pat. No. 5,165,625) discloses a breathable gas supply for an aircraft that includes an electric motor driven atmospheric air compressor, a switch for actuating the compressor, a feed pipe in communication with the compressor outlet, and a two-position selector for regulating the connection between the pipe, the compressor and the supply.

The Suchar patent (U.S. Pat. No. 6,641,088 B2) discloses a pilot controlled analgesia system for subduing hijackers that includes a pressurized source of disabling gas stored in the aircraft and released by manual or electronic means by the pilot for deployment into the passenger compartment of the airliner.

The Lay patent (U.S. Pat. No. 6,812,859 B2) discloses an anti-hijack system that includes an alarm device mounted to each passenger seat and interconnected to a cockpit display so that passengers can activate the alarm device on their own for the release of disabling gas to thwart a hijacking before its get under way.

The Boveja et al. patent (U.S. Pat. No. 6,696,928 B1) discloses a method and system for countering hostile activities on an airplane and which includes built-in defense systems that include chemical sprays, laser guns, and pre-programmed alarm systems.

Nonetheless, despite the ingenuity of the above systems, methods and devices, there remains a need for a counter hijacking system that is easy to install, reliable, and avoids the problems of arming the crew or flight attendants.

### SUMMARY OF THE INVENTION

The present invention comprehends a counter hijacking system for an airliner that can be easily installed on new airliners or retrofitted to existing airliners, and which is a simple, non lethal and cost effective way to protect and save the lives of passengers and crew members by thwarting unruly passengers, hijackers or terrorists before they have fully undertaken their dangerous actions and plans, and without resorting to deadly force.

Thus, the present invention includes a plurality of receivers spaced along both sides of the passenger compartment and generally located immediately below the overhead storage compartments. The receivers are electrically interconnected to each other and with the electrical system of the airliner. In addition, the receivers are electrically interconnected to an alarm located in the cockpit of the airliner. Each flight attendant carries a portable, pocket-sized transmitter that has a 30-foot range and which is immediately pressed upon the discernment of a dangerous situation arising within the passenger compartment. Upon being pressed the transmitter immediately sends a signal to the nearest receiver, and then the receiver transmits an alarm signal to the alarm alerting the flight deck crew (pilot and copilot) of the dangerous situation in the passenger compartment.

Interconnected to the oxygen lines that extend throughout the passenger compartment is a source or supply of incapacitating or disabling knockout gas. When the alarm sounds or lights in the cockpit, the pilot presses a toggle switch that actuates a flow control valve to open so that the knockout gas can be introduced into the oxygen lines for dispersal throughout the passenger compartment effectively rendering both passengers and the dangerous actors (the unruly parties, hijackers or terrorists) unconscious in a few minutes. The flight deck crew (pilot, copilot, and possibly navigator) is separated by a bulkhead from the passenger compartment, and has their own separate cockpit oxygen supply source. After the knockout gas has taken effect, and a predetermined time period has elapsed for ensuing that the knockout gas has taken effect, the crewmembers can enter the passenger compartment and administer a counter agent to the flight attendants for reviving the flight attendants. Upon being revived the flight attendants can then identify the party or parties that need to be subdued, and the flight crew can use nylon restraints to physically restrain the individual or individuals for the rest of the flight. A stun gun can also be available to assist in the restraining process. In due course the passengers will awaken and the airliner will land whereupon the restrained individuals can be handed over to the proper authorities.

It is an objective of the present invention to provide a counter hijacking system for an airliner whose deployment doesn't endanger the lives of the passengers and flight crew in the process of disabling the hijacker or terrorist.

It is another objective of the present invention to provide a counter hijacking system for an airliner that avoids and obviates the problems associated with having loaded weapons available to the flight crew.

It is yet another objective of the present invention to provide a counter hijacking system for an airliner that significantly reduces the need for deploying armed sky marshals aboard airliners.

Yet another objective of the present invention is to provide a counter hijacking system for an airliner that is a simple, non-lethal, and cost effective deterrent to controlling and subduing unruly passengers, hijackers and terrorists.

Still another objective of the present invention is to provide a counter hijacking system for an airliner that utilizes off-the-shelf items and components.

Still yet another objective of the present invention is to provide a counter hijacking system for an airliner that can be inexpensively added to new airliners or retrofitted to existing airliners.

A still further objective of the present invention is to provide a counter hijacking system for an airliner that is incorporated with and uses the electrical power system of the airliner in which it is installed.

These and other objects, features and advantages will become apparent to those skilled in the art upon a perusal of the following detailed description read in conjunction with the accompanying drawing figures and appended claims.

### BRIEF DESCRIPTION OF THE DRAWINGS

FIG. 1 is a top plan view of the counter hijacking system for an airliner of the present invention illustrating the primary components of the system disposed throughout the fuselage of the airliner and which include the alarm, the valve switch, the flow control valve, the receivers electrically interconnected to the alarm and the supplies of oxygen and disabling gas;

FIG. 2 is a sectioned elevational view of the counter hijacking system for an airliner of the present invention illustrating the disposition of several receivers at 15-foot intervals along the passenger compartment and beneath the overhead storage compartments;

FIG. 3 is a schematic view of the counter hijacking system for an airliner of the present invention illustrating the electrical interconnection and signal transmissions from the transmitter to the nearest receiver and thence to the cockpit alarm;

FIG. 4 is a schematic plan view of the counter hijacking system for an airliner of the present invention illustrating the introduction of the knockout agent into the oxygen supply line for dispersal within the passenger compartment of the airliner;

FIG. 5 is a sectioned plan view of the counter hijacking system for an airliner of the present invention illustrating the oxygen supply for the cockpit of the airliner;

FIG. 6 is a schematic view of the counter hijacking system for an airliner of the present invention illustrating the sequence of steps for the introduction of the knockout gas into the passenger compartment of the airliner;

FIG. 7 is a top plan view of the counter hijacking system for an airliner of the present invention illustrating the extension of the oxygen lines throughout the fuselage of the airliner;

FIG. 8 is an elevational view of the counter hijacking system for an airliner of the present invention illustrating the container for the counter agent that is administered to counteract the effects of the knockout agent;

FIG. 9 is an elevational view of the counter hijacking system for an airliner of the present invention illustrating a representative stun gun that can be used as a backup for the knockout agent; and

FIG. 10 is a perspective view of the counter hijacking system for an airliner of the present invention illustrating representative restraints that can be used to secure the hijackers or terrorists after the knockout gas has immobilized them.

### DETAILED DESCRIPTION OF THE PREFERRED EMBODIMENT

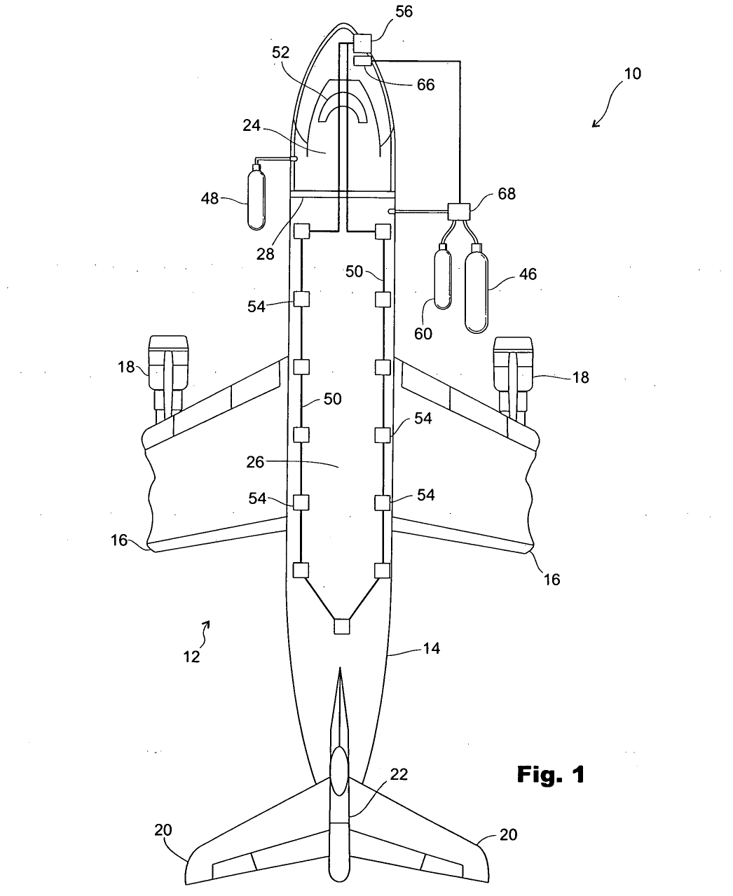

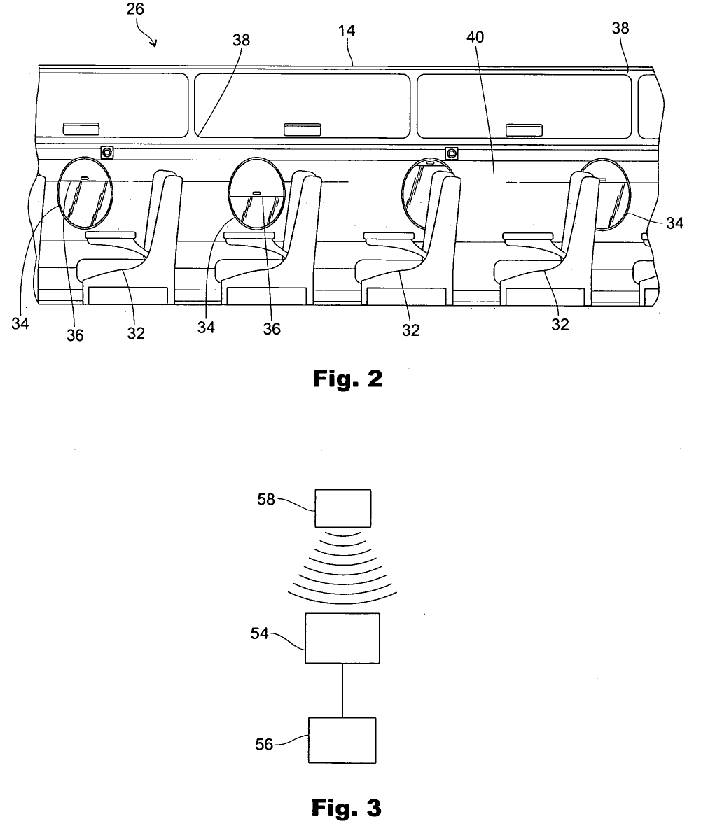

Illustrated in FIGS. 1-10 is a counter hijacking system 10 for an airliner that provides a simple, effective and non-lethal method of thwarting and preventing incidents in airliners that could injure or kill the flight crew members or the passengers, or, in a worst case scenario, bring down the airliner. The dangerous situations could be caused by drunken, unruly, boisterous passengers or by hijackers and terrorists seeking to cause maximum destruction and death. The counter hijacking system 10 of the present invention is designed to by a safe and non-lethal means of saving the lives of the crewmembers and passengers while incapacitating the targeted individuals enabling the airliner to safely land for turning the targeted individuals over to the proper authorities.

Thus, a representative airliner 12 is illustrated in FIGS. 1, 2, 5 and 6, and includes a fuselage 14, a pair of wings 16 each of which includes at least one engine 18, a horizontal stabilizer 20 and opposed vertical stabilizers 22. In addition, a cockpit area 24 that is separated from a passenger compartment 26 by a bulkhead 28 further defines the fuselage 14. The interior of the passenger compartment 26 includes rows of seats 32 on either side of an aisle with each row of seats 32 including a window 34 with a pull down shutter 36 and an overhead storage compartment 38 located above the respective rows of seats 32 and mounted to each interior sidewall 40 of the fuselage 30. The airliner 12 also includes oxygen supply lines 42 that extend throughout the cockpit 24 and the passenger compartment 26 for distributing and discharging fresh air through overhead ducts 44 located above each row of seats 32. The portion of the oxygen supply lines 42 that extend into the cockpit area 24 are separated from the portion of the oxygen supply lines 42 extending throughout the passenger compartment 26 by standard shields or baffles (not shown). The passenger compartment 26 has its own passenger oxygen supply or source 46 and the cockpit 24 has a cockpit oxygen supply or source 48 with the cockpit oxygen supply 48 for providing oxygen to the cockpit area 24 but being separate from the passenger compartment oxygen supply 46 for safety reasons hereinafter further explained.

As shown in FIGS. 1, 2 and 7, extending throughout the cockpit area 24 and the passenger compartment 26 is an electrical system consisting of interconnected electrical wires 50. The electrical system is connected (hardwired) to the instrument control panel 52 located within the cockpit area 24. Spaced along both interior sidewalls 40 of the passenger compartment 26, and preferably concealed behind the respective sidewalls 40, is a plurality of receivers 54 that are interconnected to each other by the electrical wires 50 of the electrical system. As specifically shown in FIG. 1, the receivers 54 are spaced 15 feet apart from each other along the length of the passenger compartment 26 and are electrically interconnected (hardwired) to an alarm 56 located within the cockpit 24. Each flight attendant will carry a portable transmitter 58 having at least a 30-foot transmission range, and the transmitters 58 will function similar to a standard key fob used for opening a vehicle door. Because of the 15-foot spacing of the receivers 54, the transmitters 58 carried by all the flight attendants will be within the range of at least two receivers 54 no matter where the flight attendants are standing or situated within the passenger compartment 26.

As shown in FIGS. 1, 2, 4 and 7, the system 10 also includes a source or supply 60 for holding or containing therein an amount or volume of incapacitating knockout gas 62 with the source or supply 60 interconnected to and in flow communication with the oxygen supply lines 42 that extend through the passenger or cabin compartment 26. The knockout gas supply 60 can be a canister or container located within the fuselage and which is in flow communication with the oxygen supply lines 42 that extend throughout the passenger compartment 26. At the appropriate time the knockout gas 62 is released from the supply 60 for entrainment with the cabin oxygen 64 and conveyance through the oxygen lines 42 for introduction into the passenger compartment 26 in order to render unconscious and effectively incapacitate for a predetermined time period the threatening party or parties. The introduction of the knockout gas 62 also incapacitates the flight attendants and the passengers, but as will be hereinafter further explained, the counter hijacking system 10 provides a remedy to revive the flight attendants and, if need be, the passengers. Otherwise, the passengers revive on their own as the effects of the knockout gas 62 wear off.

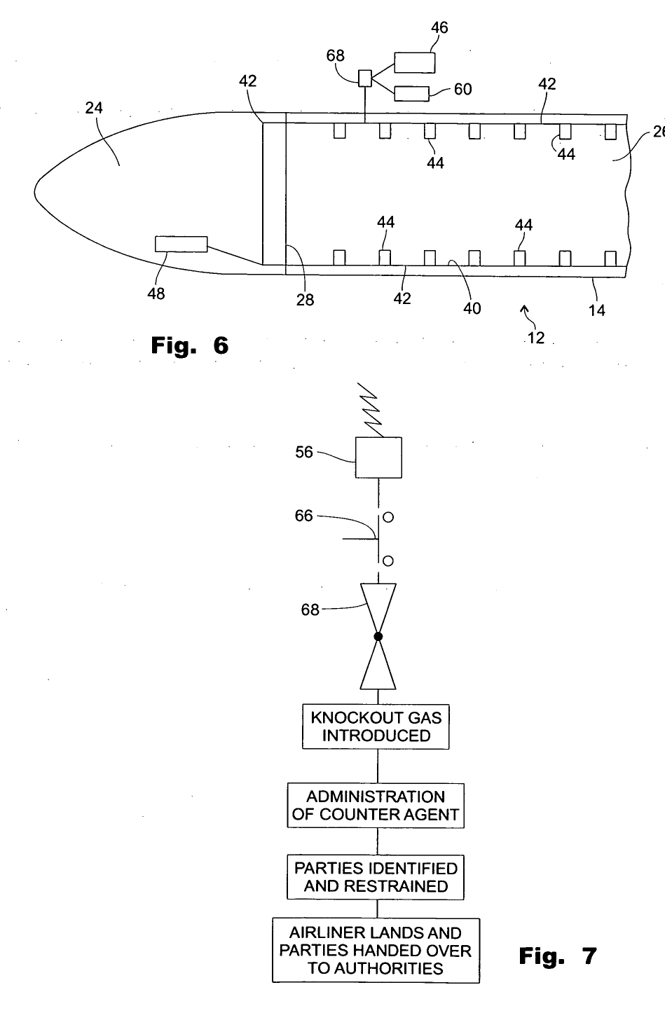

FIGS. 1 and 6 illustrate the elements that control the delivery of the knockout gas 62 from the knockout gas source 60 to the oxygen supply lines 42 and thence into the passenger compartment 26 intermixed with the normal cabin oxygen 64. Specifically, a valve switch 66, such as a toggle switch, is located within the cockpit 24 and is electrically connected to a flow control valve 68 that is disposed in the oxygen supply line 42. The opening and closing of the flow control valve 68 controls the discharge and flow of the knockout gas 62 into the oxygen lines 42, and prevents the introduction of the knockout gas 62 into the oxygen supply lines 42 during normal flight conditions.

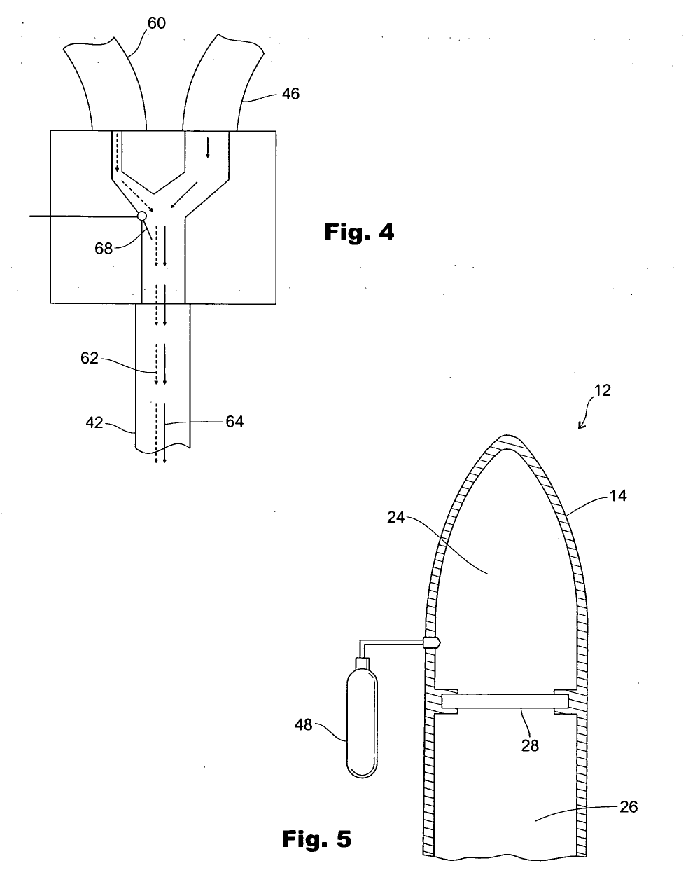

In operation, the flight attendants would each be carrying one transmitter 58, and upon the first sign of a dangerous situation or condition, at least one flight attendant would press his or her transmitter 58 that would instantly send an alarm or danger signal to the nearest receiver 54. The activated receiver 54 would in turn transmit a signal to the alarm 56 in the cockpit 24, and the alarm 56 would audibly or visually activate thereby informing the pilot and copilot that a dangerous situation is occurring in the passenger compartment 26. The pilot would then immediately engage the toggle switch 66, and the toggle switch 66 would electrically actuate the opening of the flow control valve 68 thereby allowing the rapid discharge and introduction of the knockout gas 62 into the passenger compartment 26. As shown in FIG. 4, the knockout gas 62 is entrained and intermixes with the cabin oxygen 64, and both are quickly conveyed through the oxygen lines 42 for discharge through the ducts 44 and introduction into the passenger compartment 26. As was previously noted, the cockpit 24 is separated from the passenger compartment 26 by the bulkhead 28, and the cockpit area 24 has its own cockpit oxygen supply 48 so that the individuals within the cockpit 24 (pilot, copilot, and navigator/engineer) remain unaffected by the introduction of the knockout gas 62 through the air ducts 44 and into the passenger compartment 26.

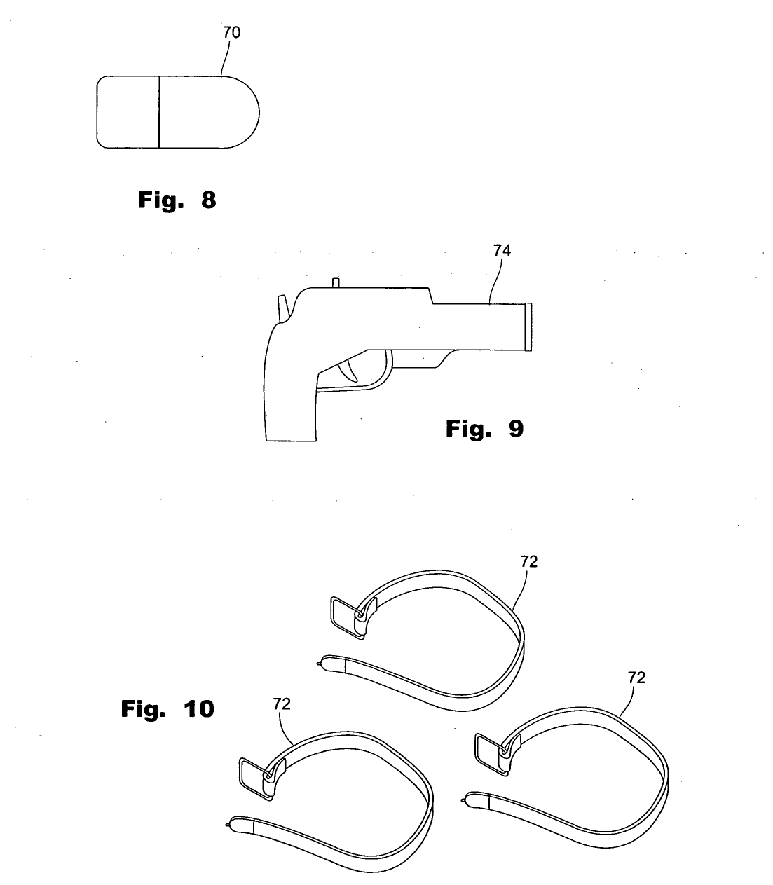

The knockout gas 62 quickly takes effect after introduction and permeation throughout the passenger compartment 26 thereby rendering unconscious the passengers, flight attendants, and the targeted disruptive and dangerous individuals. After the elapse of a predetermined time period the copilot and navigator enters the passenger compartment 26 and administers a counter agent to the flight attendants in order to revive the flight attendants. The counter agent can be contained in an ampoule or vial 70 as shown in FIG. 8. After regaining consciousness, the flight attendants can then quickly point out the individuals that need restrained, and using, for example, nylon restraints 72 as shown in FIG. 9, as well as a stun gun 74 as shown in FIG. 10 for backup, the individuals are restrained and subdued for the remainder of the flight. When the airliner 12 lands the restrained and subdued individuals can then be handed over to the appropriate law enforcement officials.

Although a preferred embodiment of the invention has been shown and described it will be apparent to those skilled in the art that numerous modifications, alterations and variations are possible and practicable while remaining within the spirit of the invention and the scope of the appended claims.

I claim:

1. A counter hijacking system for an airliner having a fuselage with the fuselage including a cockpit separated from a passenger compartment by a bulkhead, an electrical system extending through the fuselage, and oxygen supply lines for delivering oxygen to the passenger compartment, comprising:
a plurality of receivers disposed within the passenger compartment with the receivers spaced from each other at 15-foot intervals and interconnected to the electrical system;
at least one portable transmitter carried by a flight attendant for transmitting a danger signal to the nearest receiver upon the determination that a dangerous condition is occurring in the passenger compartment;
an alarm located in the cockpit and electrically connected to the receivers for sounding upon activation by the receivers;
a knockout gas supply holding a volume of knockout gas with the knockout gas supply interconnected to the oxygen supply lines;
a flow control valve for regulating the discharge of the knockout gas into the oxygen supply lines;
a manually operable toggle switch for selectively opening and closing the flow control valve; and
whereupon the transmission of the danger signal from the transmitter to the nearest receiver causes the alarm in the cockpit to sound so that a pilot or copilot can engage the toggle switch to open the flow control valve for allowing the discharge and conveyance of the knockout gas into and through the oxygen lines for introduction into the passenger compartment thereby rendering unconscious and incapacitating all individuals within the passenger compartment.

2. The counter hijacking system for an airliner of claim 1 further comprising a cockpit oxygen supply source for providing oxygen to the cockpit.

3. The counter hijacking system for an airliner of claim 2 wherein the introduction of the knockout gas into the passenger compartment does not subsequently incapacitate the pilot and copilot.

4. The counter hijacking system for an airliner of claim 3 wherein the alarm that is electrically interconnected to the receivers can visually activate for alerting the pilot and copilot of the dangerous condition in the passenger compartment.

5. The counter hijacking system for an airliner of claim 4 further comprising a plurality of nylon restraints that can be used to restrain the individuals after they have been incapacitated by the introduction of the knockout gas in the passenger compartment.

6. The counter hijacking system for an airliner of claim 5 further comprising a stun gun that can be used to subdue individuals if the introduction of the knockout gas fails to effectively incapacitate the individuals.
